(19) United States
(12) Patent Application Publication
(10) Pub. No.: US 2026/0243709 A1
(43) Pub. Date: Aug. 20, 2026

(54) SCINTILLATOR DEFECT CORRECTION IN X-RAY MICROSCOPY

(71) Applicant: Carl Zeiss X-ray Microscopy, Inc., Dublin, CA (US)

(72) Inventors: Andriy ANDREYEV, Pleasanton, CA (US); Xiaochao XU, Pleasanton, CA (US); Lars OMLOR, Nuernberg (DE); Christoph Hilmar GRAF VOM HAGEN, Schwaebisch Gmuend (DE); Matthew ANDREW, Livermore, CA (US)

(21) Appl. No.: 19/164,938

(22) PCT Filed: Mar. 22, 2024
(86) PCT No.: PCT/US2024/021031

§ 371 Date: Sep. 12, 2025

Related U.S. Application Data
(60) Provisional application No. 63/492,786, filed on Mar. 29, 2023.

(51) Int. Cl. G01N 23/046; G21K 7/00

(52) U.S. Cl. CPC G01N 23/046; G21K 7/00; G01N 2223/3035

(57) ABSTRACT

A deep learning based method and system to correct for detector defects in X-ray microscopy systems. Normal geometry projections and shifted geometry projections are collected for a given detector, creating a mapping between defective region and healthy region and a machine learning system is trained using these projections. The trained neural network system is then used to correct tomographic projection datasets improving the image quality of resultant reconstructed tomographic image volume sets.

### RELATED APPLICATIONS

This application claims the benefit under 35 USC 119(e) of U.S. Provisional Application No. 63/492,786, filed on Mar. 29, 2023, which is incorporated herein by reference in its entirety.

### BACKGROUND OF THE INVENTION

X-ray microscopy (XRM) is a powerful imaging technique for analyzing internal structure on the micro to nano scale. XRM systems provide high resolution images of samples, allowing for detailed study of their properties. XRM systems use a beam of X-rays to illuminate the samples, which is then imaged using a detector subsystem. The X-rays attenuation in the sample is then analyzed to produce an image or projection of the sample.

X-ray computed tomography (CT) is a non-destructive technique for inspecting and analyzing internal structures of samples. Tomographic volume data sets are reconstructed from a series of these projections via standard CT reconstruction algorithms, as the samples are scanned at different angles.

There are a number of different configurations for X-ray CT systems. In X-ray microscopy systems, because the X-ray sources and detector subsystems are large and the samples or objects being scanned are typically small, the X-ray sources and detector subsystems are largely fixed, while the samples are rotated in the x-ray beam, in contrast to medical CT systems in which the patient is stationary and the sources and detector subsystems rotate around the patient.

Often, scintillated detector subsystems are used in XRM systems. Scintillator detectors, such as cesium iodide (CsI), sodium iodide (NaI), lanthanum bromide (LaBr₃) and so on, convert the X-ray photons into visible light photons. The image formed on the scintillator screen is then imaged by charge coupled device (CCD) or complementary metal oxide semiconductor (CMOS) sensor array to convert the readings into spatial distribution map of detected X-ray flux intensities. Scintillators are often coupled to the sensor array with or without one or more photographic lenses, but using microscope objective lenses provide the highest resolution, being better than a micrometer in the best cases.

It is evident that the quality of X-ray image will heavily depend on the quality of the scintillator detectors. For example, any imperfection in the scintillator material can affect the accuracy of the measurement. Typical root causes for such imperfections are unsuccessful polishing, impurities, cracks, water damage (for hygroscopic scintillators), etc. Such defects can frequently result in the need to either replace the scintillator entirely or having certain algorithmic corrections applied. Replacing and finding perfect defect-free detector assembly is difficult, time-consuming, and expensive process, which also negatively impacts manufacturing yields. Therefore, algorithmic correction if done properly can be the right way of dealing with detector defects.

Such defects can often appear as bright dots of several pixel diameters, when CT image reconstruction is performed, those dots will translate into streaks in the final 3D volume set. Thus, correction post-reconstruction is difficult, as the artifacts are highly correlated and obscuring. Only if such defects are sufficiently small (occupying no more than 1-2 pixels on the image sensor) and are not connected, they can be removed by means of median filter or inpainting with minimum impact on image quality.

### SUMMARY OF THE INVENTION

The problem arises when such defects occupy several pixels on the image sensor.

The inpainting can be either insufficient or cause different artifacts as well.

Another complication for the removal of such artifacts is the fact that scintillator defects can differently affect the image quality depending on the sample and the X-ray-sample interaction. This makes removal more difficult than simple image subtraction or inpainting (as the region and influence changes).

Other distortions can be further arise depending on the detector type, resulting in severe artifacts in X-ray projection images. To give an example, some of X-ray microscopy systems that use optical magnifications to better resolve visible light from a scintillator can suffer from optical aberrations especially in the peripheral regions.

The present invention preferably employs a deep learning based method to correct for such defects. Such correction methods and system can be either pre-trained (during a periodic calibration step) or trained on the fly per sample type or acquisition conditions.

The correction for the errors is done in two steps.

In the first step, a mapping-out of the detector defective areas can be done. This could be realized via no-sample imaging operation with X-ray source on (air scan). Any discrepancies (zero signal regions, overly high intensity regions, unstable, flickering regions) can be noted either by automatic software or by manual review, Also, in the first step, the areas that distort the spatial coordinates of the detected X-ray flux location are mapped. For this, a calibration phantom (e.g., in the form of the grid) can be used.

Next step is done with a characteristic sample object or calibration phantom. Pairs of projection images are then acquired, one at normal geometry, and one at shifted geometry. This shifted geometry is obtained with either a shifted X-ray source or a shifted sample stage or a shifted detector, or any combinations of these shifts. Each projection pair (normal and shifted) are acquired so that they visualize the portion of a sample with and without detector defect obstruction.

The normal geometry projection and the shifted geometry projection for a given sample stage rotation (theta) angle ensures that the part or parts of the sample that were previously obscured by the one or more defective detector regions now fall into an area of the scintillator detect that are defect free.

The corresponding input and training target images of the sample or calibration phantom are then registered, and deep convolutional neural network is trained to learn the transformation rules between the area obscured by the defective region and the same area as visible in the non-defective region of the detector.

During the standard acquisition the trained network is to be applied to acquired data to correct for defects.

In general, according to one aspect, the invention features a method for compensating for detector defects in an X-ray microscopy system. Often these defects include isolated, space limited imperfections such as scintillator scratches, polishing defects, impurities, dead pixels.

The method comprises collecting a pair of a normal geometry projection and shifted geometry projection with a detector for each defect of the detector and training a machine learning system using the pairs of the normal geometry projection and shifted geometry projection. Each projection pair (normal and shifted) are acquired so that they visualize the portion of a sample with and without detector defect obstruction. The method then includes correcting tomographic 2D projection datasets and/or tomographic volume sets using the trained machine learning system.

The shifted geometry projections can be collected by shifting a sample, an x-ray source, and/or a detector, for example. Preferably, the projections are collected at the same acquisition parameters as projections of a sample that are to be corrected.

Typically, several pairs of the normal geometry projections and shifted geometry projections are collected at different sampling theta angles.

The defects of the detector can be mapped such as with a no-sample imaging operation (air scan).

In a current implementation, the machine learning system includes a neural network.

Correcting the tomographic 2D projection datasets and/or tomographic volume sets can include deriving correction factors for each defect and possibly even for each defect and acquisition parameters.

In some examples, the pairs of the normal geometry projection and shifted geometry projection are collected with a phantom.

Preferably, the shifted geometry projections are collected by shifting a sample or phantom, an x-ray source, and/or a detector. The projections should be collected at the same or similar acquisition parameters as the projections that are corrected.

It is preferred that the training set of normal geometry projections and shifted geometry projections are collected at different theta angles which allows to better sample the acquisition conditions.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale, emphasis has instead been placed upon illustrating the principles of the invention. Of the drawings:

FIG. 1 is a schematic diagram of an x-ray microscopy system to which the present invention is applied in one embodiment;

FIG. 2 is a flow diagram illustrating defect correction of the present invention; and

FIGS. 3A, 3B, and 3C are schematic diagrams showing the registration of the defect areas to the clean areas, acquisition of the training data pairs, and training of the defect correction network.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

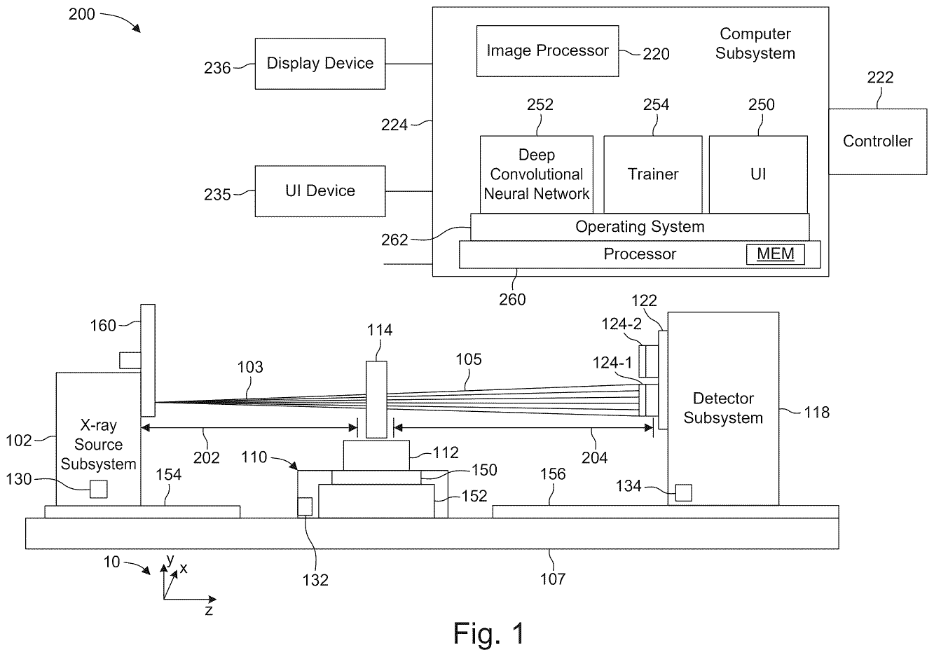

FIG. 1 is a schematic diagram of a XRM system 200 to which the present invention is applicable.

The illustrated microscopy system 200 is an X-ray CT system and generally includes several subsystems. An X-ray source subsystem 102 generates a polychromatic or possibly monochromatic X-ray beam 103. An object stage subsystem 110 with object holder 112 holds a sample or object 114 in the beam and positions and repositions it to enable scanning of the sample 114 in the stationary beam 103, 105. A detector subsystem 118 detects the beam 105 after it has been modulated by the sample. A base, such as a platform or optics table 107, provides a stable foundation for the microscopy system 200 and its subsystems.

In general, the object stage subsystem 110 has the ability to position and rotate the sample 114 in the beam 103. Thus, the object stage subsystem 110 will typically include linear and rotation stages. The illustrated example has a precision 3-axis stage 150 that translates and positions the sample along the x, y, and z axes, very precisely but only over relatively small ranges of travel. This allows a region of interest of the object 114 to be located within the beam 103/105. The 3-axis stage 150 is mounted on a theta stage 152 that rotates the 3-axis stage 150 and thus sample 114 in the beam around the y-axis. The theta stage 152 is in turn mounted on the base 107.

Thus, the frame of reference or coordinate system of the 3-axis stage 150 is related to the frame of reference or coordinate system 10 of the microscopy system 200 by the angular position of the theta stage 152.

The source subsystem 102 will typically be either a synchrotron X-ray radiation source or alternatively a “laboratory X-ray source” in some embodiments.

As used herein, a “laboratory X-ray source” is any suitable source of X-rays that is not a synchrotron x-ray radiation source. Laboratory x-ray source 102 can be an X-ray tube, in which electrons are accelerated in a vacuum by an electric field and shot into a target piece of metal, with X-rays being emitted as the electrons decelerate in the metal. Typically, such sources produce a continuous spectrum of background x-rays combined with sharp peaks in intensity at certain energies that derive from the characteristic lines of the selected target, depending on the type of metal target used.

In one example, source subsystem 102 is a rotating anode type or microfocused source, with a Tungsten target. Targets that include Molybdenum, Gold, Platinum, Silver or Copper also can be employed. Preferably a transmission configuration is used in which the electron beam strikes the thin target from its backside. The x-rays emitted from the other side of the target are used as the beam 103.

The x-ray beam generated by source subsystem 102 is often conditioned to suppress unwanted energies or wavelengths of radiation. For example, undesired wavelengths present in the beam are eliminated or attenuated, using, for instance, energy filters (designed to select a desired x-ray energy range (bandwidth)) held in a filter wheel 160. These energy filters typically include an ‘air’ filter corresponding to no filter along with a set of low energy filters for filtering lower energy x-rays and high energy filters for filtering higher energy x-rays.

When the object 114 is exposed to the X-ray beam 103, the X-ray photons or particles, which propagate through the sample 114, form a modulated beam 105 that is received by the detector subsystem 118. In some other examples, an objective lens is used to form an image onto the detector subsystem 118 of the microscopy system 200.

Typically, a magnified projection image of the object 114 is formed on the detector subsystem 118. The magnification of the x-ray stage is equal to the inverse ratio of the source-to-object distance 202 and the source-to-detector distance 204.

To achieve high resolution, an embodiment of the x-ray CT system 200 further utilizes several optical objectives offering different optical magnifications. In one example, the detection system includes a very high resolution detector 124-1. In one example, this high-resolution detector 124-1 has camera, a scintillator, and a microscope objective to provide additional optical magnification in a range between 2× and 100×, or more. The scintillator converts the x-rays into an optical image that are magnified by the microscope objective and then detected by the camera.

Other detectors are often included as part of the detector subsystem 118. For example, the detector subsystem 118 can include a lower resolution detector 124-2. This could be a scintillator and flat panel detector or a camera with a lower magnification microscope objective, in examples. Configurations of one, two, or even more detectors 124 of the detector subsystem 118 are possible.

Preferably, the two or more detectors 124-1, 124-2 are mounted on a turret 122 of the detector subsystem 118, so that they can be alternately rotated into the path of the modulated beam 105 from the sample 114.

Typically, the source subsystem 102 and the detector subsystem 118 are mounted on respective z-axis stages. For example, in the illustrated example, the source subsystem 102 is mounted to the base 107 via a source stage 154, and the detector subsystem 118 is mounted to the base 107 via a detector stage 156. In practice, the source stage 154 and the detector stage 156 are lower precision, high travel-range stages that allow the source subsystem 102 and the detector subsystem 118 to be moved into position, often very close to the object during scanning and then be retracted to allow the object to be removed from, a new object to be loaded onto, and/or the object to be repositioned on the object holder 112 of the object stage subsystem 110.

The operation of the microscopy system 200 and the scanning of the object 114 is controlled by a computer subsystem 224 that often includes an image processor 220 and a controller 222.

The computer subsystem 224 includes one or more processors 260 along with their data storage resources such as disc or solid-state drives, and memory MEM. The processors 260 execute an operating system 262 and various applications run on that operating system 262 to allow for user control and operation of the microscopy system 200. Particularly, user interface app 250 provides a graphical control interface for the system. It enables the user to configure acquisition parameters. In addition, a machine learning app implements a deep convolution neural network 252 to correct for detector defects. This is trained by a training app 254 that also executes on the operating system 262.

User input device(s) 235 such as a touch screen, computer mouse, and/or keyboard enable interaction between the operator and the computer subsystem 224.

The controller 222 allows the computer subsystem 224 to control and manage components in the X-ray CT microscope 200 under software control. The controller might be a separate computer system adapted to handle realtime operations or an application program executing on the processor 260. The source subsystem 102 includes a control interface 130 allowing for its control such as setting the X-ray source voltage and choosing a filter on the source filter wheel 160 and monitoring by the controller 222. Similarly, the object stage subsystem 110 and the detector subsystem 118 have respective control interfaces 132, 134 for allowing for their control and monitoring by the computer subsystem 224 via the controller 222.

To configure the microscopy system 200 to scan the sample and to adjust acquisition parameters such as the geometrical magnification, X-ray source voltage, X-ray source filtration, camera exposure time, number of frames, and overall number of projections, the operator utilizes the user interface rendered on the display device 236 and generated by the user interface application 250. The source-to-object distance 202 and the source-to-detector distance 204 are set by respective operation of the source stage 154 and detector stage 156 to achieve the desired scanning setup. In addition, the x-ray source voltage and filter are sent to the source subsystem 102. The camera exposure time, number of frames, and overall number of projections are set by interaction with the detector subsystem 118.

Specifically, the source stage 154 and detector stage 156 include respective motor encoder systems or other actuator systems that allow the computer system 224 via the controller 222 to position the respective x-ray source subsystem 102 and the detector subsystem 118 to specified positions via the control interfaces 130, 134. Further, the source stage 154 and detector stage 156 signal the controller 222 of their actual positions.

The operator of the system under automatic control operates the object stage subsystem 110 to perform the CT scan via computer subsystem, the controller 222 and the control interfaces 130, 132, 134. Typically, the object stage subsystem 110 will position the object by rotating the object about an axis that is orthogonal to the optical axis of the x-ray beam 103, 105 by controlling the theta stage 152 and/or position the sample in the x, y, z axes directions using stage 150.

Using the user interface rendered on the display device 236 by the user interface app 250, the operator defines/selects scanning set up including the acquisition parameters via the UI devices 235. These acquisition parameters include X-ray source voltage settings that help to determine the X-ray energy spectrum and exposure time and number of frames on the X-ray source subsystem 102. The operator also typically selects other settings such as the field of view of the X-ray beam 103 incident upon the sample 114, the number of X-ray projection images to create for the sample 114, and the detector 124-1, 124-2 selected. Generally, the acquisition parameters include X-ray source voltage, X-ray source filtration, camera exposure time, number of frames, and overall number of projections and the scanning setup includes the angles to rotate the sample by the stage subsystem 110. In addition, the source-to-object distance 202 and the source-to-detector distance 204 are often specified and these are converted to the necessary positions or settings for the source stage 154 and detector stage 156 as part of the scanning setup.

### Operation

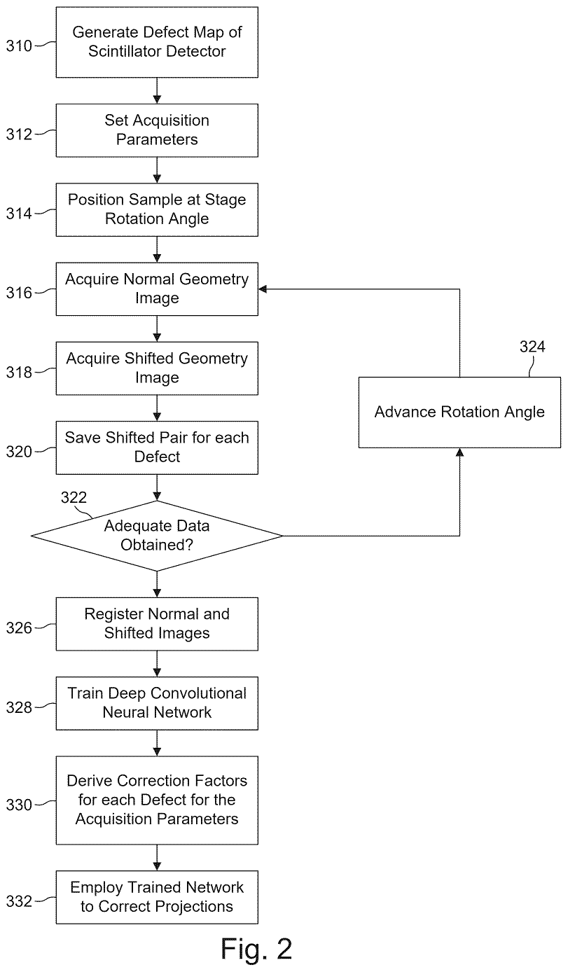

FIG. 2 is a flow diagram showing the steps employing deep learning based method to correct for detector defects.

In step 310, the detector defect areas are mapped. In one example, the imaging operation is performed with X-ray source on air scan, i.e., no sample object present in the field of view (FOV). Any discrepancies (zero signal regions, overly high intensity regions, unstable, flickering regions) noted either by automatic image analysis performed by the trainer app 254 or by manual review. This is preferably performed with no sample installed. Optionally, calibration phantom (e.g., in the form of the grid) used as the sample, especially when needed to map out regions that lead to spatial distortions.

It should be noted that the correction for such detector inefficiencies becomes very difficult to solve once the sample is positioned in the FOV. The sample itself can filter and scatter the X-ray source beam. As a result, the correction steps derived from air scan and/or phantoms can become unreliable and can only offer marginal correction in the presence of an arbitrary sample.

The challenge is addressed by implementing pre-imaging sample effect calibration step. This is a sample-specific correction derivation that is performed for a particular set of acquisition parameters. In this case, for a particular sample, one needs to perform a series of acquisitions as follows. Specifically, desired acquisition parameters are specified including the X-ray source voltage, X-ray source filtration, camera exposure time in step 312.

The sample is further positioned at specific geometry and sample stage rotation angle in step 314.

One or several pairs of projection images are acquired, one at normal geometry in step 316, and one at shifted geometry in step 318. This shifted geometry is obtained with either a shifted X-ray source or a shifted sample stage or a shifted detector, or any combinations of these shifts (optionally combined with tilts or rotations). The effect is to shift the location of the defects in the plane of the detector's image sensor, x-y plane. Thus, each projection pair (normal and shifted) are acquired so that they visualize the portion of a sample with and without detector defect obstruction.

In general, one or more shifted projections are obtained for each defect to ensure that each of the mapped defects is shifted to a region of the detector that is defect-free.

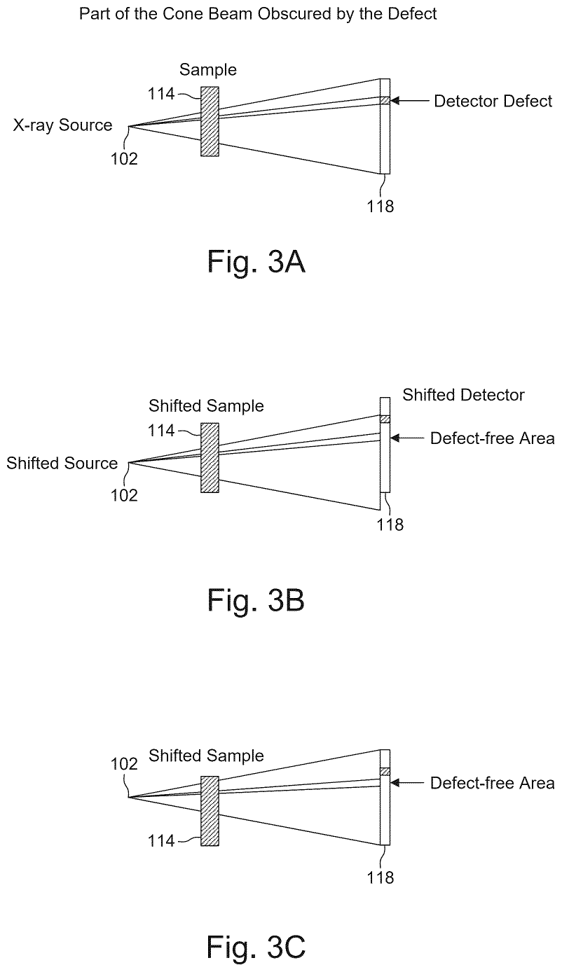

These shifts are shown in FIGS. 3A, 3B, and 3C. FIG. 3A shows the projection acquired at the normal geometry and the location of the defect in the detector plane. FIG. 3B shows the projection acquired at the shifted geometry by shifting the source 102 and/or sample 114 and/or detector 118. FIG. 3C shows the projection acquired at the shifted geometry by only shifting sample 114. In either of these two later cases, the portion of the sample is shifted from the detector defect so that a defect free response can be synthesized.

These pairs are saved in step 320.

The normal and shifted geometry are further preferably collected from a range of theta angles by repeating this process and incrementing the theta stage 152 in step 324, until an adequate dataset has been obtained as determined in step 322.

The normal geometry projection and the shifted geometry projection for a given sample stage rotation (theta) angle ensures that the part or parts of the sample that were previously obscured by the one or more defective detector regions now fall into an area of the scintillator detector that are defect free.

Multiple combinations of such shifted pairs are recorded for every known detector defect, ideally for different parts of the sample and different stage rotation angles. The directions and the corresponding shift lengths can be pre-determined manually for a given detector defect map, or they can be determined on the fly based on the geometry. Each projection pair (normal and shifted) are acquired so that they visualize the portion of a sample with and without detector defect obstruction.

Then the corresponding input and training target images are registered in step 326, and deep convolutional neural network 252 is then trained by the trainer 254 to learn the transformation rules that can best correct for the defects in the input images in step 328. This method is certainly more reliable if the defect area is not too large, and/or there is still signal ideally in correlation with the sample being detected in such area.

During the standard acquisition the trained network can then be applied to acquired data to correct for defects by deriving a set of correction factors in step 330 for the acquisition parameters.

Since machine learning methods are used to derive the set of correction factors, these factors are then employed on the correction of the projection data 332 acquired from similar samples within the sample class and for given acquisition parameters 312.

Optionally, classical inpainting techniques can be used, deriving the parameters from data pairs 326.

As another alternative, direct machine learning methods can be used. This could take the following forms:

-Projection images are usually normalized with reference images that are collected without objects. This flattens the intensity distribution of the source (and detector). This normalization is usually done by a pointwise division (log-subtraction). If the reference image is corrupted by detector artifacts this is a particular problem as those artifacts are now introduced into all normalized projections. Normalization can be included into learning approaches to avoid this problem. For example, a convolutional neural network can have the projection and the reference as input and the normalized artifact corrected projection as output. This kind of network could also include a pointwise division layer to reflect the classical normalization operation. Alternatives to this is to use log-transform (which is necessary for later steps of tomography anyway) and then rely on linear operators (difference).

Training of machine learning methods relies on ground truth data. In case of detector artifacts this can be generated using multiple methods like simulation or dithering. A particularly clean way to generate artifact free projection could be to record projections using a dithering technique (wobbling the detector to avoid artifacts corruption the same pixels between projections), reconstruct the object (maybe even using an artifact reduction method already) and then recreate the projections using a forward projection operation. This kind of training data can be generated for each device to custom train networks to clean the specific detector attached to the device/machine.

Depending on the imaging geometry the detector defects leave a particular path through the projection data. In the case of a regular circular trajectory this path takes sinusoidal path line (always the same pixels are corrupted) in the sinogram. Thus, a well-known removal algorithm of those defects is to use the sinograms and to remove stripes/lines. This is of course a direct alternative to using single projections for defect removal. A particular removal method that performs very well in practice is based on this sinogram de-striping. This method uses an intensity sorting along the direction of the defect path (lines along the sinogram) which keeps the lines/stripes intact but transforms the intensity profile not belonging to the stripes into a smooth surface. The second step is then a filtering operation orthogonal to the lines which removes the lines but has a very minimal effect on the smooth intensity profile. The last step after the filtering is to undo the sorting operation (which is an application of the inverse permutation of the pixels that was used for sorting them in the first place). This sorting-unsorting operation can be easily combined with machine learning based artifact removal as a pre and postprocessing step (even for arbitrary geometry this can be used as the artifacts align after a proper geometry alignment procedure).

Detector defect map 310 can be updated during regular quality control activities, e.g., yearly.

For defect detection, uncorrelated areas between forward projections of the reconstructed uncorrected 3D volume image and original projection data can be used.

In summary, the present approach can improve the image quality produced by imperfect detectors, as well as increase the intrinsic tolerance to the detector defects, so less of them will be disqualified during the acceptance testing, thus improving the production yields.

While this invention has been particularly shown and described with references to preferred embodiments thereof, it will be understood by those skilled in the art that various changes in form and details may be made therein without departing from the scope of the invention encompassed by the appended claims.

1. A method for compensating for detector defects in an X-ray microscopy system, the method comprising:
collecting a pair of a normal geometry projection and shifted geometry projection with a detector for each defect of the detector;
each projection pair (normal and shifted) are acquired so that they visualize the portion of a sample with and without detector defect obstruction;
training a machine learning system using the pairs of the normal geometry projection and shifted geometry projection; and
correcting tomographic 2D projection datasets and/or tomographic volume sets using the trained machine learning system.

2. The method as claimed in claim 1, wherein the shifted geometry projections are collected by shifting a sample, an x-ray source, and/or a detector.

3. The method as claimed in claim 1, wherein the projections are collected at the same acquisition parameters as projections of a sample that are to be corrected.

4. The method as claimed in claim 1, wherein several pairs of the normal geometry projections and shifted geometry projections are collected at different sampling theta angles.

5. The method as claimed in claim 1, further comprising mapping defects of the detector such as with a no-sample imaging operation (air scan).

6. The method as claimed in claim 1, wherein the machine learning system includes a neural network.

7. The method as claimed in claim 1, wherein correcting the tomographic 2D projection datasets and/or tomographic volume sets includes deriving correction factors for each defect.

8. The method as claimed in claim 1, wherein correcting the tomographic 2D projection datasets and/or tomographic volume sets includes deriving correction factors for each defect and acquisition parameters.

9. The method as claimed in any claim 1, wherein the pairs of the normal geometry projection and shifted geometry projection are collected with a phantom.

10. An X-ray microscopy system, comprising:
an X-ray source subsystem of generating X-rays;
an object stage subsystem for holding a sample in the X-rays;
a detector subsystem for detecting the X-rays after interaction with the sample; and
a computer for receiving projections from the detector subsystem and controlling the system to collect a normal geometry projection and shifted geometry projection with a detector for each defect of the detector such that each projection pair (normal and shifted) are acquired so that they visualize the portion of a sample with and without detector defect obstruction, training a machine learning system using the pairs of the normal geometry projection and the shifted geometry projection, and correcting tomographic projection datasets and/or tomographic volume sets using the trained machine learning system.

11. The system as claimed in claim 10, wherein the shifted geometry projections are collected by shifting a sample, an x-ray source, and/or a detector.

12. The system as claimed in claim 10, wherein the projections are collected at the same acquisition parameters as projections of a sample that are to be corrected.

13. The system as claimed in claim 10, wherein several pairs of the normal geometry projections and shifted geometry projections are collected at different sampling theta angles.

14. The system as claimed in claim 10, further comprising mapping defects of the detector such as with a no-sample imaging operation (air scan).

15. The system as claimed in claim 10, wherein the machine learning system includes a neural network.

16. The system as claimed in claim 10, wherein correcting the tomographic 2D projection datasets and/or tomographic volume sets includes deriving correction factors for each defect.

17. The system as claimed in claim 10, wherein correcting the tomographic 2D projection datasets and/or tomographic volume sets includes deriving correction factors for each defect and acquisition parameters.

18. The system as claimed in claim 10, wherein the pairs of the normal geometry projection and shifted geometry projection are collected with a phantom.
